(19) United States
(12) Patent Application Publication
(10) Pub. No.: US 2012/0236466 A1
(43) Pub. Date: Sep. 20, 2012

(54) Lithium Ion Capacitor and Layered Member for Lithium Ion Capacitor

(75) Inventors: Yukio IIDA, Saitama (JP); Toshinori Dozono, Ibaraki (JP); Hideaki Uehara, Ibaraki (JP); Goichi Tatsumi, Shiga (JP); Yuuji Ooyama, Ibaraki (JP); Haruki Hoshi, Saitama (JP); Masaaki Sekiya, Saitama (JP)

(73) Assignee: Shin-Kobe Electric Machinery Co., Ltd., Tokyo (JP)

(21) Appl. No.: 13/050,400

(22) Filed: Mar. 17, 2011

(51) Int. Cl. H01G 9/155; B32B 3/10

(52) U.S. Cl. 361/502; 428/596

(57) ABSTRACT

A mass-producible lithium ion capacitor that allows lithium ions to be easily occluded by a negative electrode in advance is provided. A layered member includes: two copper foils each having a portion in which tabs are formed on one side along the longitudinal direction of the copper foils, and a portion in which a large number of through holes are formed and which is disposed adjacent to the portion with the tabs, and lithium metal having a thin plate shape and sandwiched between the copper foils to contact the portions with the through holes of the copper foils. The tabs are joined to a negative current collector ring, and electrically connected to a negative current collecting member. By leaving the layered member to stand for a predetermined period, it is possible to cause lithium ions to be occluded by a negative active material of the lithium ion capacitor.

### BACKGROUND OF THE INVENTION

1. Field of the Invention

The present invention relates to a lithium ion capacitor and a layered member as a lithium ion source for the lithium ion capacitor that causes a negative active material to occlude lithium ions in advance.

2. Description of the Related Art

In a lithium ion capacitor, lithium ions are occluded, or doped, in a negative electrode in advance so that the potential of the negative electrode is kept lower than that in a normal electric double-layer capacitor. Therefore, the lithium ion capacitor can provide a wide usable voltage range. Since the lithium ion capacitor can also serve as a positive electrode charge/discharge mechanism that can utilize cation adsorption in addition to anion adsorption commonly utilized in an ordinary electric double-layer capacitor, thereby obtaining double capacity in principle. In addition, while the lithium ion capacitor has a small capacity compared to a lithium ion battery, the lithium ion capacitor advantageously has a low internal resistance, excellent output characteristics, and a long life. Japanese Patent Application Publication No. 2007-067105 (JP2007-067105A), which is related to the present invention, discloses a lithium ion capacitor in which lithium metal for occlusion or doping of lithium ions is wound in an electrode group. FIG. 7 of the publication discloses a layered member having a metal foil in which a plurality of through holes are formed and lithium metal held by the metal foil.

Active researches and developments are being conducted on lithium ion capacitors. However, most lithium ion capacitors disclosed in patent publications are in a testing stage before mass production, and further studies are to be made on specific configurations of mass-producible lithium ion capacitors and mass-production technologies for the lithium ion capacitors.

### SUMMARY OF THE INVENTION

An object of the present invention is to provide a mass-producible lithium ion capacitor that allows lithium ions to be easily occluded by a negative electrode in advance and a layered member as a lithium ion source for the lithium ion capacitor.

A first aspect of the present invention provides a layered member as a lithium ion source for the lithium ion capacitor that causes a negative active material to occlude lithium ion in advance in a container for a lithium ion capacitor. The layered member according to the present invention includes: two metal foils each including a portion in which a large number of through holes are formed and a portion in which through holes are not formed and which is provided adjacent to the portion with the through holes; and lithium metal having a thin plate shape and sandwiched between the two metal foils to contact the portions with the through holes of the two metal foils. The two metal foils each including the portion with the through holes and the portion without through holes may be formed by folding a single metal foil that is twice longer.

In the first aspect, preferably, the lateral cross-sectional area of the through hole formed in the portion with the through holes of the metal foils may be 8 (10⁻⁷ m² or less.

The lower limit value of the area of the through hole may be set to allow passage of lithium ions. In the metal foils, the portion without through holes may be provided with a plurality of tabs formed at predetermined intervals. The area of the portion with the through holes may be larger than the area of the lithium metal. The plurality of tabs may be formed by cutting the copper foils into a comb-like shape. The metal foils may be made of a material selected from the group consisting of copper, nickel, a copper alloy, and a nickel alloy.

A second aspect of the present invention provides a lithium ion capacitor including an electrode group including a positive electrode, a negative electrode and a separator, a non-aqueous electrolyte and a container for housing the electrode group and the non-aqueous electrolyte. The positive electrode has a positive current collector and an active material mixture supported on the positive current collector. The negative electrode has a negative current collector and an active material mixture supported on the negative current collector. The lithium ion capacitor also includes the layered member according to the first aspect disposed in or adjacent to the electrode group while being insulated from the positive electrode. In the lithium ion capacitor, only the metal foils are left in the layered member, because lithium ions from the lithium metal are occluded in a negative active material in the active material mixture of the negative electrode.

The present invention is applicable to lithium ion capacitors including an electrode group in a wound structure or in a layered structure. In the electrode group in a wound structure, for example, the positive and negative electrodes are wound with the separator provided therebetween. The positive current collecting member and a negative current collecting member each have a profile selected from a ring shape, a triangular shape, and a polygonal shape. The container has a cylindrical shape. Preferably, the layered member is arranged between two surfaces of the two separators sandwiching the positive electrode or the negative electrode and is disposed on an extension line of the positive electrode or the negative electrode. It is preferable that the layered member is wound with the positive electrode, the negative electrode and the separators while being insulated from the positive electrode. The start ends of the separators may be fixed to the axial core and the ending ends of the separators may form the peripheral surface of the electrode group. In this case, the separators may be not divided in the electrode group. The layered member may be partially wound in the electrode group such that the layered member is deposited at at least one of a position before a wound start portion of the negative electrode, a position in a wound portion of the negative electrode, and a position after a wound end portion of the negative electrode. The positive electrode may comprise at least two divided positive electrodes which are spaced from each other in the longitudinal direction of the positive electrode. In this case, the layered member may be wound in the electrode group while being disposed between the two divided positive electrodes. In this case, preferably, the layered member is wound by one turn or less in the electrode group. If the layered member is insulated from the positive electrode, the layered member must not be disposed on an extension line of the positive electrode. That is, the layered member may be disposed in the electrode group such that the layered member insulated from the positive electrode is positioned over the negative electrode and the both surfaces of the layered member face the negative electrode. Alternatively, the layered member may be disposed in the electrode group such that one surface of the layered member faces the negative electrode and the other surface of the layered member does not face the positive electrode but faces the winding axis or the negative electrode. Further, the layered member may directly contact with the negative electrode not via the separator. In this case, the layered member may face the negative electrode via or not via the separator. If the layered member is disposed at the outermost periphery of the electrode group, one surface of the layered member may face the negative electrode via or not via the separator and the other surface of the layered member may face the negative electrode via or not via the separator. The layered member may face the container via or not via the separator.

Preferably, the metal foils of the layered member are electrically connected with the negative current collector with the active material mixture of the negative electrode.

According to the present invention, the layered member is disposed in or adjacent to the electrode group of the lithium ion capacitor in advance where the layered member is electrically insulated from the positive electrode and the capacitor including the layered member is left for a predetermined period. As the result, it is possible to cause the lithium metal to be dissolved in the non-aqueous electrolyte and to cause the lithium ions to be occluded in the negative active material forming the active material mixture of the negative electrode.

### BRIEF DESCRIPTION OF THE DRAWINGS

FIG. 1 is a cross-sectional view of a lithium ion capacitor according to an embodiment to which the present invention is applicable.

FIG. 2A is a plan view of an electrode of the lithium ion capacitor according to the embodiment before being wound, and FIG. 2B is a plan view of a current collecting member forming the electrode.

FIG. 3 is an enlarged cross-sectional view schematically showing the vicinity of a portion of the electrode in which a lead piece is formed.

FIG. 4A is a plan view schematically showing that slurry is applied to the electrode in an applicator. FIG. 4B is a diagram schematically showing the applicator. FIG. 4C shows the entirety of an application device.

FIG. 5A is a cross-sectional view schematically showing that an active material mixture is applied to a portion of the current collecting member in which through holes are formed from an application port disposed on one side of the portion with the through holes. FIG. 5B is a cross-sectional view schematically showing that the active material mixture is applied to the portion with the through holes from application ports disposed on both sides of the portion with the through holes.

FIG. 6 shows a cutting device.

FIG. 7 is a plan view showing the positions at which the cutting device cuts an aluminum foil.

FIG. 8A is a perspective view showing the appearance of a layered member, and FIG. 8B is a cross-sectional view of the layered member.

FIG. 9 is an explanatory view schematically showing an electrode group which has not yet been wound.

FIG. 10 is a perspective view schematically showing the appearance of the electrode group.

FIG. 11 is a diagram schematically showing the center portion of a winding device.

FIG. 12 is a perspective view schematically showing the appearance of an electrode group according to another embodiment.

FIG. 13 is an exemplary view schematically showing the electrode group of FIG. 12 which has not yet been wound.

FIG. 14 is another exemplary view schematically showing the electrode group of FIG. 12 which has not yet been wound.

### DESCRIPTION OF THE PREFERRED EMBODIMENTS

An embodiment in which the present invention is applied to a cylindrical lithium ion capacitor will be described below with reference to the drawings.

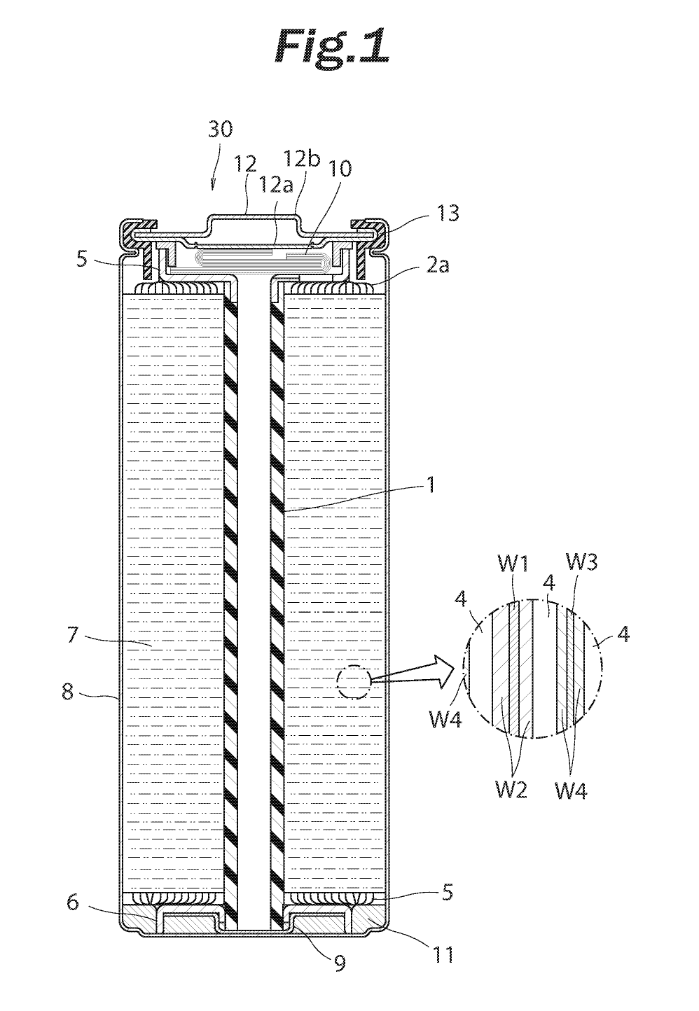

As shown in FIG. 1, a lithium ion capacitor 30 (hereinafter simply referred as a “capacitor 30”) according to the embodiment has a bottomed cylindrical container (can) such as a stainless can, a nickel can, a nickel-plated copper can, a nickel-plated steel can, or a copper can. The container 8 houses a hollow cylindrical axial core 1 made of an insulating resin such as polypropylene, a phenol resin, or nylon, for example, and an electrode group 7 including an elongated positive electrode 2, an elongated negative electrode 3, and a separator 4. The hollow cylindrical axial core 1 may be provided with a plurality of (in this example, three) slits extending in the vertical direction, or may be provided with holes.

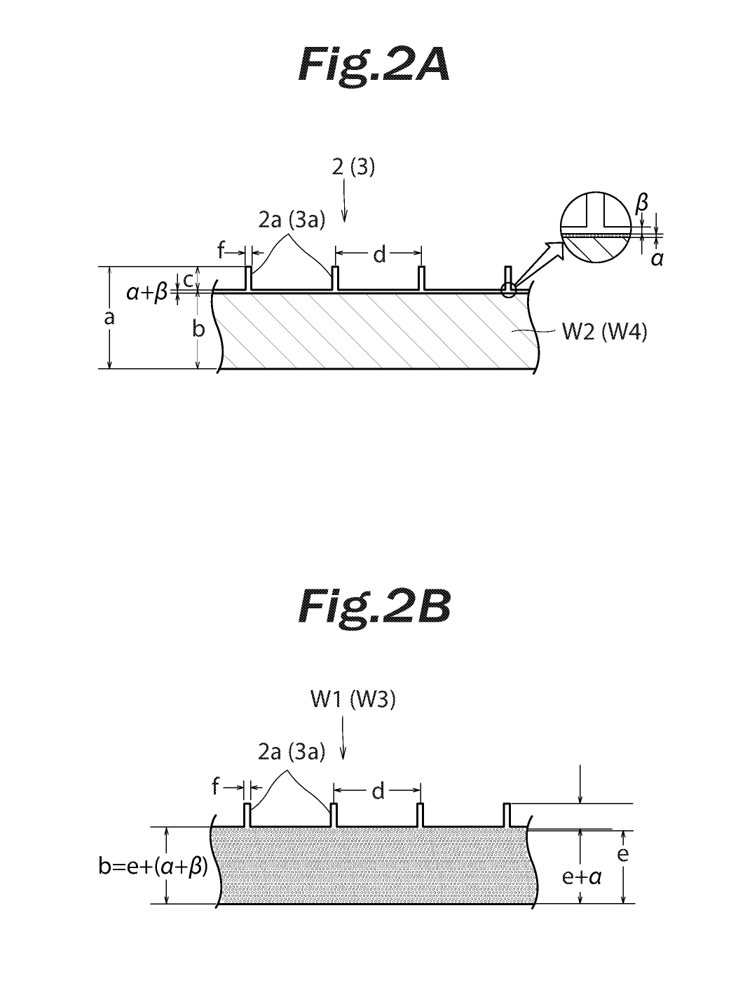

As shown in FIGS. 2A and 2B, the positive electrode 2 has an aluminum foil (positive current collecting member) W1 with a thickness of 10 to 50 μm, for example, and a positive active material mixture W2 containing activated carbon as a positive active material and applied to both surfaces of the aluminum foil W1 (also see FIG. 1). The aluminum foil W1 is cut into a comb-like shape on one side along the longitudinal direction of the aluminum foil W1. The aluminum foil W1 includes positive electrode lead pieces 2a which are uncut portions, and a portion in which a large number of through holes are formed. The portion having the through holes formed therein is located adjacent to the positive electrode lead pieces 2a. The aluminum foil W1 also includes a portion in which through holes are not formed. The portion having no through holes formed therein is located adjacent to a portion having the through holes formed therein and the lead pieces. The positive active material mixture W2 discussed above is applied to the portion having the through holes formed therein. An area applied with the positive active material mixture W2 has a length less than the length of the portion formed with the through holes as measured in the width direction.

The negative electrode 3 has substantially the same structure as that of the positive electrode 2. That is, the negative electrode 3 has a copper foil (negative current collecting member) W3 with a thickness of 9 to 20 μm, for example, and a negative active material mixture W4 capable of occluding or releasing lithium ions and applied to both surfaces of the copper foil W3. The copper foil W3 is cut into a comb-like shape on one side along the longitudinal direction of the copper foil W3. The copper foil W3 includes negative electrode lead pieces 3a which are uncut portions, and a portion in which a large number of through holes are formed and which is located adjacent to the negative electrode lead pieces 3a. The copper foil W3 also includes a portion in which through holes are not formed. The portion having no through holes formed therein is located adjacent to the lead pieces and the portion having the through holes formed therein. The negative active material mixture W4 discussed above is applied to the portion formed with the through holes. An area applied with the negative active material mixture W4 has a length less than the length of the portion formed with the through holes as measured in the width direction.

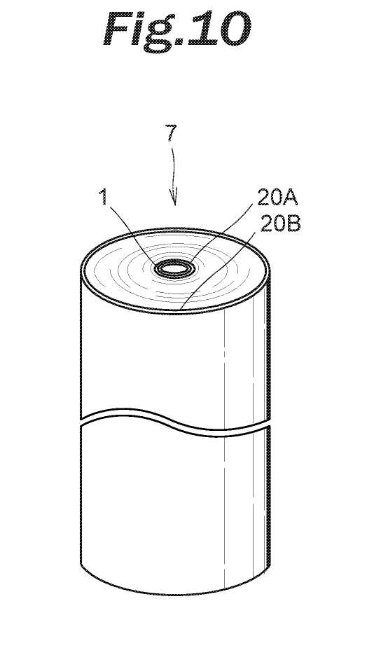

As shown in FIG. 1, the electrode group 7 comprises the positive electrode 2 and the negative electrode 3 which are layered via two separators 4 which prevent the positive electrode 2 and the negative electrode 3 from directly contacting each other. The separators 4 are made of a resin or paper and each have a thickness of 10 to 80 μm. The layered electrodes and the separators are wound about the axial core 1 into a swirling shape as seen in cross section to form the electrode group 7. Layered members (see reference numerals 20A and 20B in FIG. 10) are wound in the electrode group 7. The Layered members will be discussed in detail later. The positive electrode lead pieces 2a and the negative electrode lead pieces 3a are disposed opposite to each other in the electrode group 7 and project from each of ends of the separators 4 by a predetermined length (for example, 4 mm). The electrode group 7 is set to have a predetermined inside diameter (for example, 4 to 20 mm) and a predetermined outside diameter (for example, 15 to 70 mm) by adjusting the lengths of the positive electrode 2, the negative electrode 3, the separators 4, and so forth. Winding end portions of the elements in the electrode group 7 are fixed by an adhesive tape to prevent unwinding of the electrode group 7.

A negative current collector ring 6 made of copper is disposed below the electrode group 7 and facing the lower end surface of the electrode group 7 to collect a current from the negative electrode 3. The outer peripheral surface of the lower end portion of the axial core 1 is fitted with the inner peripheral surface of the negative current collector ring 6. The distal end portions of the negative electrode lead pieces 3a led out from the negative electrode 3 are joined to the outer peripheral portion of the negative current collector ring (negative current collecting member) 6 by resistance welding, ultrasonic welding, laser welding, or the like. A negative electrode lead plate 9 made of copper is disposed below and connected to the negative current collector ring 6. The negative electrode lead plate 9 is joined to the inner bottom portion of the container 8, which also serves as the negative electrode external terminal, by resistance welding, ultrasonic welding, laser welding, or the like. The negative current collector ring 6 and the negative electrode lead plate 9 maybe covered with an insulating material 11 made of a resin such as an epoxy resin. The insulating material 11 may be provided from the top of the negative current collector ring 6 to the inner bottom surface of the container 8. In this case, the bottom portion of the container 8 is filled with the insulating material 11.

A positive current collector ring (positive current collecting member) 5 made of aluminum is disposed above the electrode group 7 such that the positive current collector ring 5 faces the electrode group 7 in a axial direction of the axial core, to collect a current form the positive electrode 2. The positive current collector ring 5 is fitted with the upper end portion of the axial core 1. The distal end portions of the positive electrode lead pieces 2a led out from the positive electrode 2 are joined to the peripheral edge of a flange portion of the positive current collector ring 5 by resistance welding, ultrasonic welding, laser welding, or the like. The flange of the positive current collector ring 5 integrally extends from the periphery of the positive current collector ring 5.

A container lid 12 is disposed above the positive current collector ring 5 and serves as the positive electrode external terminal. The container lid 12 includes a lid casing 12a and a lid cap 12b disposed on the lid casing 12a. The container lid 12 is assembled by stacking the lid cap 12b on the lid casing 12a and calking or swaging the peripheral edge of the lid casing 12a to the lid cap 12b. The lid casing 12a may be provided with a groove that operates as a valve in response to a rise in internal pressure. The lid casing 12a may be provided with a valve that opens in response to a rise in internal pressure. Each of two positive electrode lead plates 10 if formed by layering ribbon-like aluminum foils. A first end of one of the two positive electrode lead plates 10 is joined to the upper surface of the positive current collector ring 5. A first end of the other positive electrode lead plate 10 is joined to the outer bottom surface of the lid casing 12a forming the container lid 12. Second ends of the two positive electrode lead plates 10 are joined to each other.

The container lid 12 is calked or swaged to the upper portion of the container 8 via a gasket 13 made of a resin having insulation and heat-resistance properties. Therefore, the internal space of the capacitor 30 is hermetically sealed. An on-aqueous electrolyte (not shown) is poured into the container 8. An amount of a non-aqueous electrolyte is enough to infiltrate the entirety of the electrode group 7.

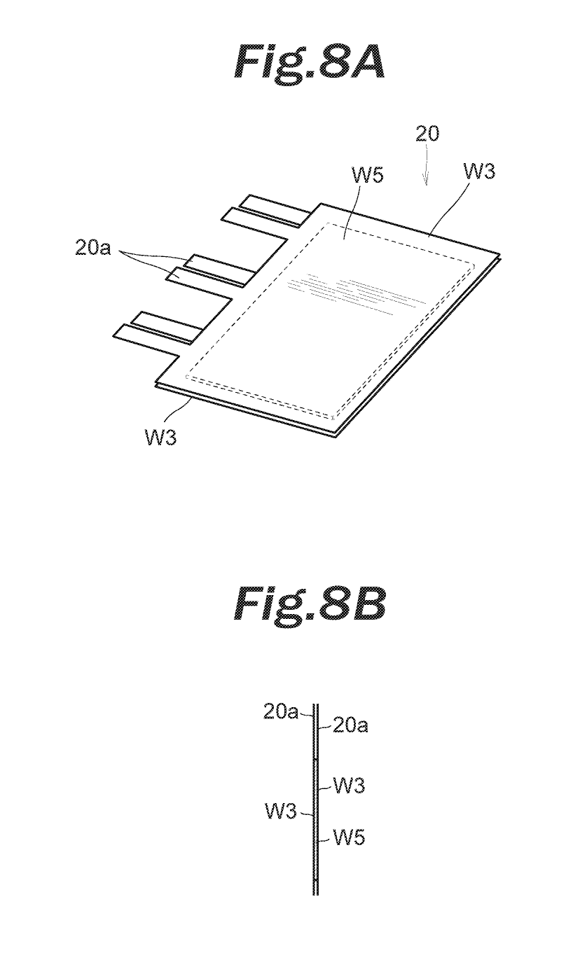

Here, layered members for causing the negative active material (in this example, amorphous carbon) of the negative electrode 3 to occlude lithium ions will be described. As shown in FIGS. 8A and 8B, the layered member 20 includes lithium metal W5 having a thin plate shape and two copper foils W6. The copper foils W6 may be obtained by cutting the same material as that for the copper foil W6 forming the negative electrode 3 into predetermined dimensions. That is, the copper foils W3 each include a portion in which tabs 20a (which are the same as the negative electrode lead pieces 3a but are referred to as “tabs” to avoid confusion) are formed on one side along the longitudinal direction of the copper foils W6. The copper foils W6 each also include a portion in which a large number of through holes are formed and which is disposed adjacent to the portion with the tabs 20a. The lithium metal W5 is sandwiched in contact with the portions formed with the through holes of the two copper foils W6. The through hole formed in the portion with the through holes has a circular shape with a diameter of 0.05 to 0.6 mm. The through holes in the portion formed with the through holes may each have an oval or polygonal shape having a substantially same area as the circular shape. The two copper foils W6 may each have an aperture ratio of 5 to 60%. The through holes are substantially uniformly distributed over the unit area.

The area of the portion with the through holes formed in the copper foils W6 is larger than the area of the lithium metal W5. The lithium metal W5 is disposed at a center of the portion with the through holes. If the lithium metal W5 is sandwiched between the portions formed with the through holes in the copper foils W6, the lithium metal W5 becomes sticky when the lithium metal W5 and the copper foils W6 are subjected to pressure by a roll device. Thereby, a layered structure of the lithium metal W5 and the copper foil W6 may be maintained by the stickiness of the lithium metal W5.

Preferably, the tabs 20a are formed by cutting the copper foils W6 into a comb-like shape, and the plurality of tabs 20a are formed at predetermined intervals. However, the copper foils W6 of the layered members 20 are of the same material for the copper foil W3 of the negative electrode 3 as discussed above. The layered members 20 are disposed at two locations, namely, at the inner peripheral portion and the outer peripheral portion of the electrode group 7 (see FIG. 10). The layered member 20 disposed at the inner peripheral portion of the electrode group 7 may be provided with only one tab 20a. In addition, the tabs 20a formed on the two copper foils W6 are led out in the same direction. The copper foils W6 each also include a portion, in which through holes are not formed and which is located adjacent to the portion formed with the tabs, along the longitudinal direction (a portion with a width β in FIGS. 2A and 2B).

The total amount of the lithium metal W5 (in this example, the total amount of the lithium metal W5 in the two layered members disposed at the inner peripheral portion and the outer peripheral portion of the electrode group 7) is set to an amount that is enough to allow the negative active material of the negative electrode 3 to occlude sufficient lithium ions. The total amount of the lithium metal W5 may be set by performing a logical computation in consideration of the material and the amount of the negative active material and causing the negative active material to actually occlude lithium ions to observe if sufficient lithium ions are occluded. The area and the thickness of the lithium metal W5 for mass production of the layered members 20 may be set in this way.

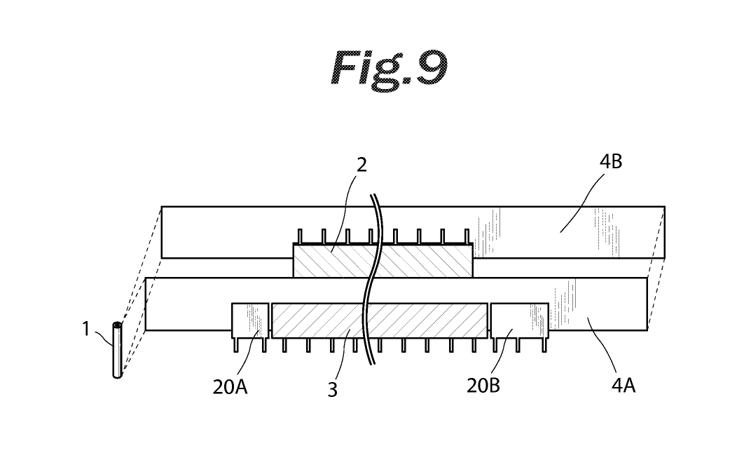

In the embodiment, as discussed above, the two layered members 20 are disposed at two locations in the electrode group 7, namely at the inner peripheral portion (in the vicinity of the axial core 1) and the outer peripheral portion (see FIG. 10). That is, the two layered members 20 are disposed before and after the negative electrode 3 in a longitudinal direction thereof in the electrode group 7 and the two layered members 20 are sandwiched between two separators 4 which sandwich the negative electrode 3 (also see FIG. 9). The arrangement and the winding of the layered members 20 will be discussed in detail later.

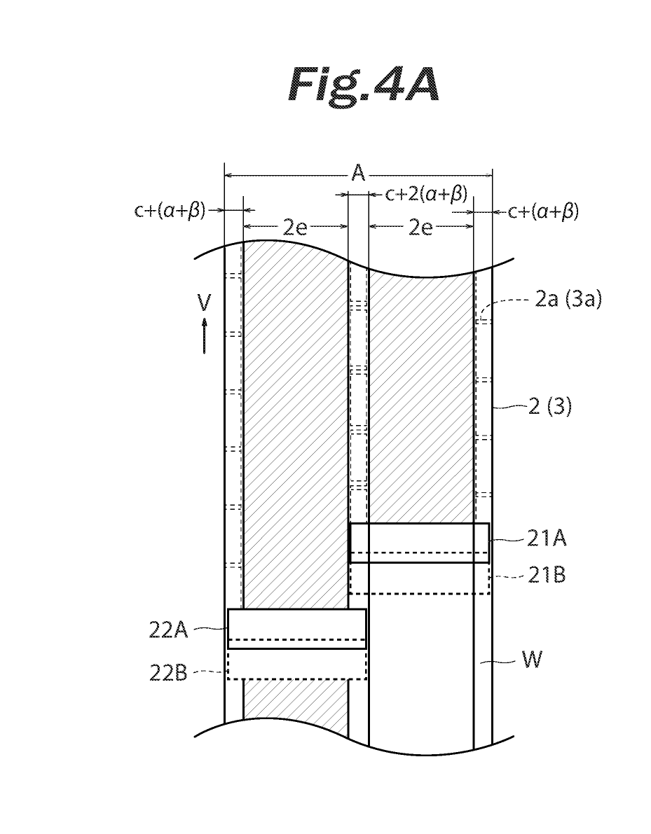

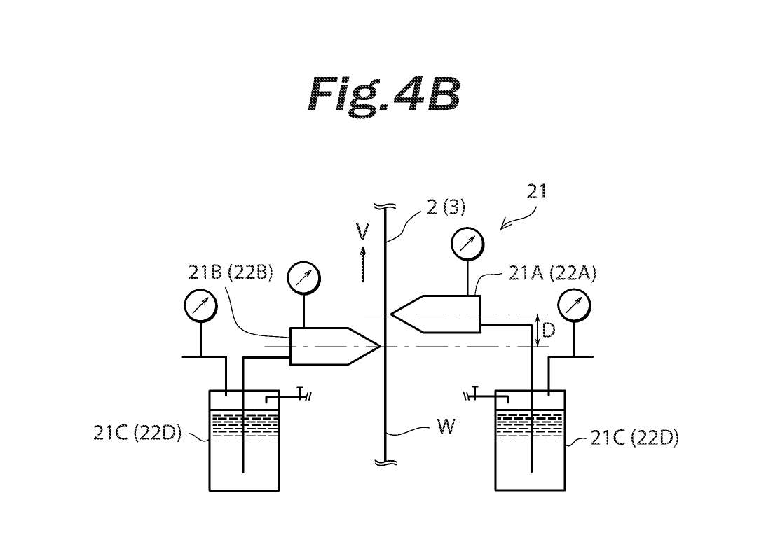

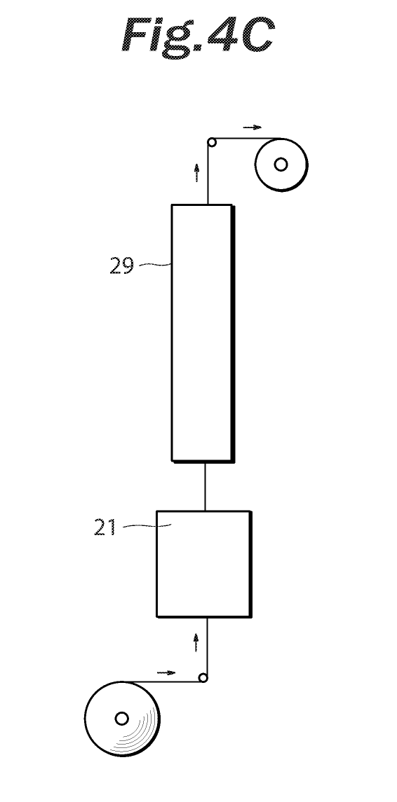

Next, the method for mass production of the capacitor 30 according to the embodiment will be mainly described. First, positive electrode slurry and negative electrode slurry are prepared. Application of slurry to the current collecting members will be described. In order to simply the description, the application of slurry to the aluminum foil W1 will be illustrated by way of example. Likewise, the application of slurry to the copper foil W3 may be described. As shown in FIG. 4B, the application of slurry to the aluminum foil W is performed by an application device 21 including four application heads 21A, 21B, 22A, and 22B each having an application port and slurry reservoirs 21C and 21D. The slurry reservoirs 21C and 21D each have a stirrer (not illustrated) and supply the slurry to each of the application heads. The positive electrode slurry is temporarily stored in the slurry reservoirs 21C and 21D.

In the application device 21 according to the embodiment, as shown in FIG. 4A, the application heads 21A and 21B apply slurry for twice the size of the positive electrode 2 in the width direction and the application heads 22A and 22B apply slurry for twice the size of the positive electrode 2 in the width direction so that slurry is applied for the total of four times the size of the positive electrode 2 in the width direction at the same time.

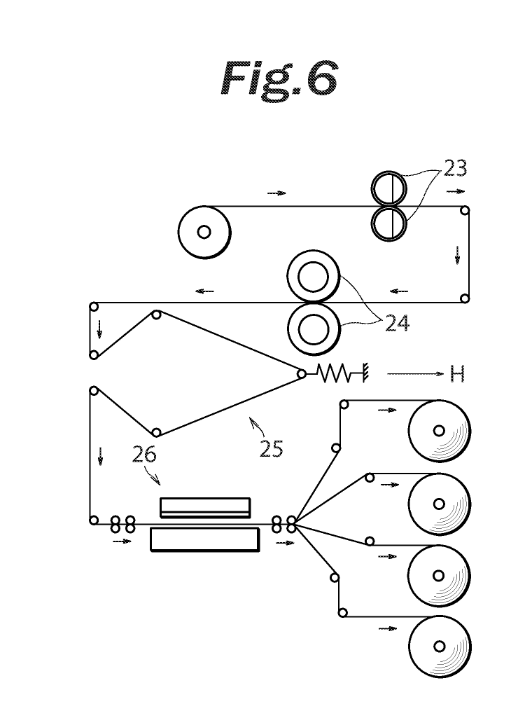

The aluminum foil W supplied from the aluminum foil supply section is transferred generally vertically (in the direction of the arrow V of FIGS. 4A and 4B) in the application device 21 via a driving roller and a driven roller (not shown) (also see FIG. 6).

In the application device 21, a predetermined air pressure is applied to the slurry reservoirs 21C and 21D to supply the slurry stored in the slurry reservoirs 21C and 21D to each of the application heads 21A, 21B, 22A, and 22B. A predetermined air pressure is applied to each of the application heads 21A, 21B, 22A, and 22B to apply the slurry from the application port of each of the application heads to both the front and back surfaces of the aluminum foil W, which is being transferred, with a substantially uniform thickness.

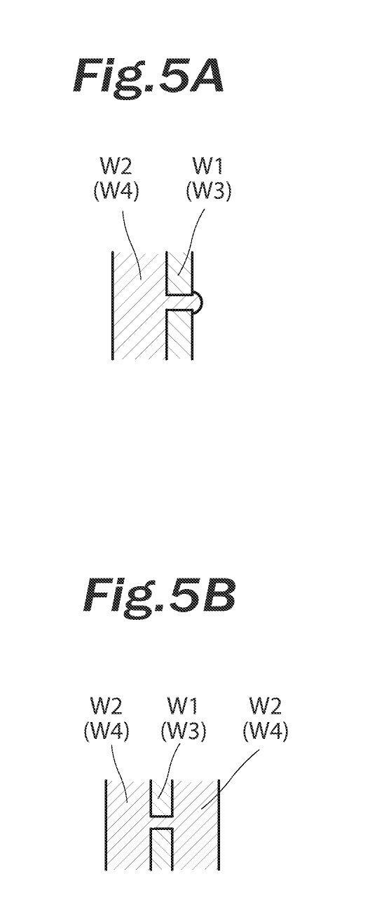

For example, slurry discharged from the application port of the application head 22B displaces air in the through holes formed in the aluminum foil W which is being transferred to reach the other surface (front surface) of the aluminum foil W as shown in FIG. 5A. Then slurry is discharged from the application port of the application head 22A disposed opposite to the application head 22B with respect to the aluminum foil W which is being transferred so that the slurry is also applied to the other surface of the aluminum foil W which is being transferred as shown in FIG. 5B.

As shown in FIG. 4C, a dryer 29 is disposed downstream of the application device 21. The slurry (including a dispersion solvent) applied to the aluminum foil W is transferred generally vertically to reach the dryer 29 through the application device 21. After being dried, the aluminum foil W to which the slurry has been applied is taken up by a take-up device into a roll formed on a pipe-like core made of metal or various types of plastic.

The positive electrode exiting from the dryer 29 and taken up into a roll is transferred to a lead piece forming device, and a portion c of the aluminum foil W to which the slurry is not applied is cut to form the positive electrode lead pieces 2a at predetermined intervals. In the cutting process discussed above, paired rollers 23, in which cutting blades having a predetermined shape are embedded in metal rollers, are prepared and the positive electrode is caused to pass between the paired rollers 23 to form the plurality of positive electrode lead pieces 2a at predetermined intervals in the portion c of the aluminum foil W in which the slurry is not applied.

Paired heat rollers 24 are disposed downstream of the dedicated paired rollers 23 to press both surfaces of the aluminum foil W to which the positive active material mixture has been applied with a predetermined line pressure. A loop mechanism. 25 and a cutting device 26 are disposed downstream of the paired heat rollers 24. The loop mechanism 25 adjusts transfer, of the aluminum. foil W to which the positive active material mixture has been applied, to the cutting device 26. The cutting device 26 cuts the aluminum foil W to which the positive active material mixture has been applied to divide the aluminum foil W into four positive electrodes 2 in the width direction.

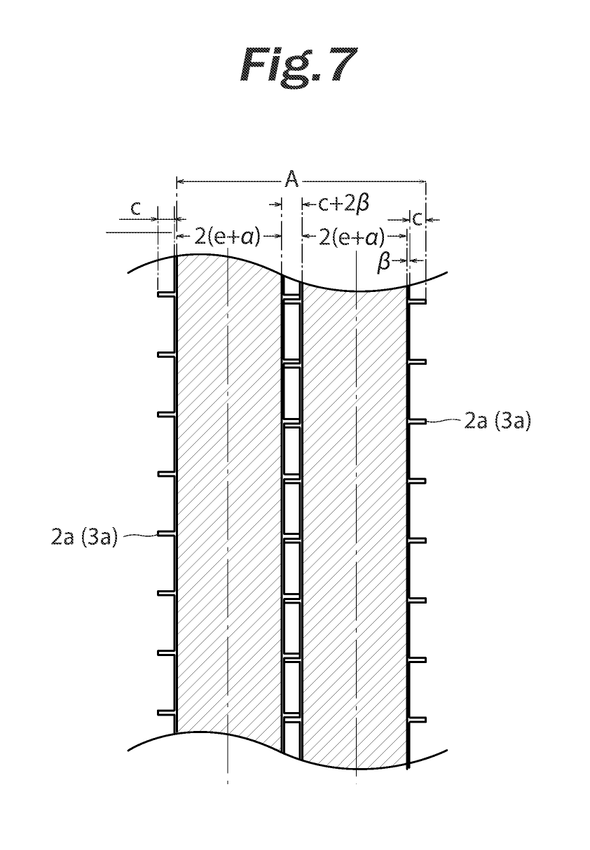

The loop mechanism 25 includes five rollers for loop transfer of the aluminum foil W in a kite shape. The cutting device 26 is disposed downstream of the loop mechanism 25. The cutting device 26 cuts the aluminum. foil W to divide the aluminum foil W into four positive electrodes 2 in the width direction. FIG. 7 shows the positions at which the cutting device 26 cuts the aluminum foil W.

The positive electrode lead pieces 2a discussed above are formed on both sides (at the left end and the right end) of the aluminum foil W, and are also formed at the middle between the portions to which the positive active material mixture has been applied. Cutting is also performed at a center of the portions to which the positive active material mixture has been applied, each of which has a width of 2 (e+α). Positive electrode take-up reels are disposed downstream of the cutting device 26 at predetermined intervals to take up the four positive electrodes 2 in a hoop shape divided in the width direction. The divided positive electrodes 2, which altogether occupy four times the width of a single positive electrode 2, are respectively taken up into a roll formed about the positive electrode take-up reels. The positive electrodes 2 (in a hoop shape) taken up into a roll may be obtained in this way. The negative electrodes 3 taken up into a roll may also be obtained in the same way.

The electrode group 7 is formed by winding the positive electrode 2, the negative electrode 3, the two separators 4, and the two layered members 20 about the axial core 1 such that the positive electrode 2 and the negative electrode 3 do not directly contact each other with the separators 4 provided therebetween and such that the positive electrode 2 and the layered members 20 do not directly contact each other. In the following description, for the sake of convenience, the separator disposed at the innermost periphery of the electrode group 7 (to contact the peripheral surface of the axial core 1) is denoted as 4A, the separator disposed at the outermost periphery of the electrode group 7 is denoted as 4B, the layered member disposed at the inner peripheral portion of the electrode group 7 is defined as 20A, and the layered member disposed at the outer peripheral portion of the electrode group 7 is defined as 20B.

The arrangement of the electrode group 7 before being wound will be described using an exploded view. As shown in FIG. 9, the layered member 20A, the negative electrode 3, and the layered member 20B are formed into a group. As shown in FIG. 9, the separator 4A is disposed behind the group, the positive electrode 2 is disposed behind the separator 4A, and further the separator 4B is behind the positive electrode 2. This structure prevents a short circuit between the constituent members discussed above even after the electrode group 7 is wound.

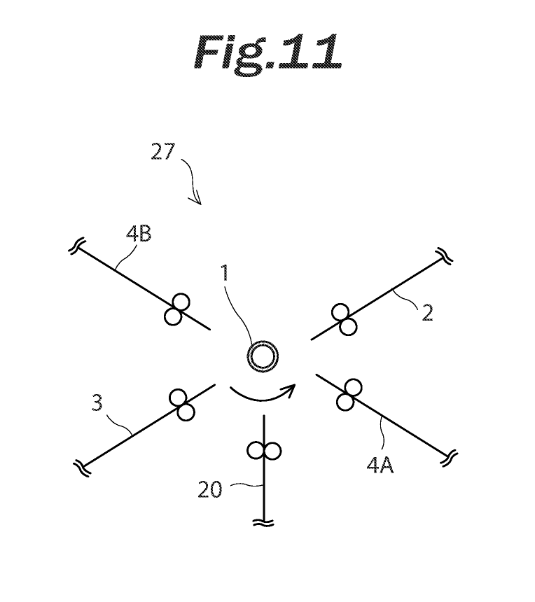

The electrode group 7 is shaped (wound) by a winding device. FIG. 11 schematically shows the essential portion (center portion) of a winding device 27 used in the embodiment. The winding device 27 has an axial core rotating section (not shown) to which the axial core 1 can be rotatably mounted. The separator 4B and a positive electrode supply section are disposed above the axial core rotating section. The positive electrode supply section for supplying the positive electrode 2, a first separator supply section for supplying the separator 4A, a layered member supply section for supplying the layered member 20, a negative electrode supply section for supplying the negative electrode 3, and a second separator supply section for supplying the separator 4B are disposed clockwise in this order from a position above and to the right of the winding axis. Each of the supply sections has a cutter (not shown) for cutting the material to be supplied in a hoop shape by a predetermined length, transfer rollers, and a transfer guide (not shown).

When an operator depresses an operation button, the axial core 1 is mounted to the axial core rotating section by a robot arm (not shown), and the first and second separator supply sections respectively start supplying the separators 4A and 4B, which are fixed to the axial core 1 using an adhesive tape. After the separators 4A and 4B are fixed, rotation of the axial core 1 and supply of the separators 4A and 4B from the first and second separator supply sections, respectively, are resumed. This causes the separators 4A and 4B to be wound about the axial core 1 by at least one turn, preferably two or three turns (also see FIG. 9).

Next, the layered member 20 is supplied from the layered member supply section. The layered member supply section cuts the layered member 20 in a hoop shape by a length corresponding to one turn using cutter (not shown), and stops supplying the layered member 20. The thus supplied layered member 20 corresponds to the layered member 20A discussed above. Then, the negative electrode supply section starts supplying the negative electrode 3 so that the negative electrode 3 is wound by one turn or more. In other words, winding of the negative electrode 3 is started after winding of the layered member 20A. Subsequently, the positive electrode supply section starts supplying the positive electrode 2. Since the positive electrode 2 is shorter than the negative electrode 3 in the longitudinal direction as discussed above, winding of the positive electrode 2 is finished by one or more turns earlier than winding of the negative electrode 3.

The positive electrode supply section cuts the positive electrode 2 by a predetermined length using the cutter (not shown), and stops supplying the positive electrode 2. The negative electrode supply section continues supplying the negative electrode 3. When a predetermined length of the negative electrode 3 is supplied, the negative electrode 3 is cut using the cutter and supply of the negative electrode 3 is stopped as with the positive electrode 2. Next, the layered member supply section resumes supplying the layered member 20. In other words, winding of the layered member 20 is started after winding of the negative electrode 3. The layered member supply section cuts the layered member 20 from the layered member supply section by a length corresponding to one turn using cutter (not shown), and stops supplying the layered member 20. The thus supplied layered member 20 corresponds to the layered member 20B discussed above.

The first and second separator supply sections continue supplying the separators 4A and 4B. When the separators 4A and 4B each having a length corresponding to at least one turn, preferably two or three turns, are supplied, the first and second separator supply sections cut the separators 4A and 4B using the cutter, and stop supplying the separators 4A and 4B (also see FIG. 9). Thus, the separators 4A and 4B are not divided in the electrode group 7. The axial core rotating section continues rotating the axial core 1 until the separators 4A and 4B form the outer periphery of the electrode group 7. After rotation of the axial core 1 is stopped, the separators 4A and 4B are placed over each other and cut to be finished at the same position. Next, an adhesive tape is affixed along the longitudinal direction of the electrode group 7 to prevent unwinding of the separators 4A and 4B wound around the outer periphery of the electrode group 7. The adhesive tape is affixed by a tape affixing section (not shown).

As shown in FIG. 9, the layered members 20A and 20B are disposed between two surfaces of the two separators 4A, 4B. One of the two surfaces is the front surface of the separator 4A and the other surface of the two surfaces is the back surface of the separator 4B. The negative electrode 3 and the layered members 20A and 20B are disposed on an extension line of the wound negative electrode 3 and are sandwiched by the separators 4A and 4B. In addition, the layered member 20A is wound before winding of the negative electrode 3, and the layered member 20B is wound after winding of the negative electrode 3. This makes it possible to obtain the electrode group 7 in which the layered members 20A and 20b are respectively disposed on the inner peripheral side and the outer peripheral side of the electrode group 7 as shown in FIG. 10. In FIG. 10, the positive electrode lead pieces 2a, the negative electrode lead pieces 3a, and the tabs 20a are omitted.

As shown in FIG. 1, the positive electrode lead pieces 2a are deformed so that all the positive electrode lead pieces 2a are gathered around the peripheral surface of the positive current collector ring 5, which is located substantially on an extension line of the axial core 1 of the electrode group 7, to contact the peripheral surface. Thereafter, the distal end portions of the positive electrode lead pieces 2a and the peripheral surface are welded to each other by resistance welding, ultrasonic welding, laser welding, or the like to join the positive electrode lead pieces 2a to the peripheral surface. The negative current collector ring 6 and the negative electrode lead pieces 3a are joined to each other in the same way as the positive current collector ring 5 and the positive electrode lead pieces 2a are joined to each other. The distal end portions of the tabs 20a of the layered members 20A and 20B are also joined to the negative current collector ring 6 in the same way. The tabs 20a and the negative electrode lead pieces 3a are joined to the negative current collector ring 6 at the same time.

Means for electrical connection of the layered member 20 to the negative electrode 3 is not necessarily limited to that described above, and may be implemented without using the tabs 20a as follows.

(1) The layered member 20 is welded, riveted, or crimped to a wound start portion of the negative electrode 3 at which winding is started (corresponding to the inner side of the wound electrode group).

(2) The layered member 20 is welded, riveted, or crimped to a wound end portion of the negative electrode 3 at which winding is finished (corresponding to the outer side of the wound electrode group).

(3) The positive and negative electrodes are divided or cut in a middle portion of the wound electrode group. An end of the layered member 20 is welded, riveted, or crimped to an end of one divided or cut negative electrode 3. The other end of the layered member is welded, riveted, or crimped to an end of the other divided negative electrode 3. During the winding operation, the separators are not divided or cut until winding is ended. The positive and negative electrodes may be further divided or cut a plurality of times.

(4) At least one or more operations of (1) to (3) above are combined with each other.

(5) The layered member 20 is disposed to directly contact the negative electrode 3 at at least one of a wound start portion, a wound end portion, and a wound middle portion of the negative electrode 3. None of the positive electrode, the negative electrode and the separators are divided or cut in the electrode group.

(6) No active material layer portion (a portion where the current collecting member is exposed) is formed in advance in a wound start portion, a wound end portion, or a wound middle portion of the negative electrode 3. The layered member 20 is disposed to directly contact the portion of the negative electrode 3 where the active material layer is not formed. The positive and negative electrodes and the separators are divided or cut in the electrode group.

Thereafter, an insulating coating is applied to the entire peripheral surface of the positive current collector ring 5. That is, an adhesive tape is wound over the peripheral surface of the positive current collector ring 5 and the outer peripheral surface of the electrode group 7 by one or more turns to serve as an insulating coating, and the electrode group 7 is inserted into the container 8. The negative electrode lead plate 9 for electrical connection is welded in advance to the negative current collector ring 6 by resistance welding, ultrasonic welding, laser welding, or the like. After the electrode group 7 is inserted into the container 8, the inner bottom portion of the container 8 and the negative electrode lead plate 9 are joined to each other by resistance welding, ultrasonic welding, laser welding, or the like utilizing the internal space of the axial core 1. Then, a predetermined amount of an epoxy resin may be poured utilizing the internal space of the axial core 1. When an epoxy resin is poured, the poured epoxy resin is solidified to form the insulating material 11.

An end of the positive electrode lead plate 10 is welded to the positive current collector ring 5 by resistance welding, ultrasonic welding, laser welding, or the like. The other end of the positive electrode lead plate 10 is joined to the lower surface of the container lid 12 (the outer bottom surface of the lid casing 12a) which seals the container 8. As discussed above, the container lid 12 includes the lid casing 12a and the lid cap 12b, which are assembled to each other in advance by stacking the lid cap 12b on the lid casing 12a and crimping or caulking the peripheral edge of the lid casing 12a.

Next, a predetermined amount of a non-aqueous electrolyte is poured into the container 8 utilizing the internal space of the axial core 1. Thereafter, the container lid 12 is fitted into the opening of the container 8 by folding the positive electrode lead plates 10. The opening portion of the container 8 is crimped or caulked with respect to the container lid 12 via the gasket 13 to obtain a tight seal. Thus, the capacitor 30 is fabricated.

Next, a method by which the lithium metal W5 of the layered members 20A and 20B is occluded in the negative active material (amorphous carbon) in the capacitor 30 according to the embodiment will be described. In the embodiment, the capacitor 30 is left to stand in a storage room controlled at a predetermined temperature (for example, room temperature) for a predetermined period (for example, two to four weeks) so that lithium ions are occluded in the negative active material. The tabs 20a of the layered members 20A and 20B are joined to the negative current collector ring 6 together with the negative electrode lead pieces 3a. Therefore, by leaving the capacitor 30 to stand for a predetermined period, the lithium metal W5 is dissolved to be occluded in the negative active material (amorphous carbon) of the negative electrode 3 because of the potential difference between the potential of the negative electrode and the potential of the lithium. Consequently, the lithium metal W5 sandwiched by the two copper foils W6 in each of the layered members 20A and 20B is dissolved so that only the two copper foils W6 are left in each of the layered members 20A and 20B.

Next, the effect or the like of the layered member 20 and the capacitor 30 according to the embodiment will be described. First, according to the layered member 20 of the embodiment, in which the lithium metal W5 is sandwiched by the copper foils W6 from both surfaces of the lithium metal W5, the workability of affixing the copper foils W6 to the lithium metal W5 is improved compared to when the copper foil W6 is affixed to one surface of the lithium metal W5. That is, in automating a process for affixing the copper foil W6 to the lithium metal W5 by pressure bonding that uses a roll or the like, if the copper foil W6 is affixed to only one surface of the lithium metal W5, the other surface of the lithium metal W5 which directly contacts the roll may adheres to the peripheral surface of the roll. If a part of the lithium metal W5 remains on the peripheral surface of the roll, the working stability may be inhibited. In addition, if the lithium metal W5 is left affixed to the peripheral surface of the roll, an abrupt oxidation reaction may occur, which may be hazardous. In order to avoid such concerns, a subsidiary material such as paper may be used to avoid direct contact between the lithium metal W5 and the peripheral surface of the roll. However, the use of paper may cause distortion due to the difference in elongation between the copper foil W6 and the paper during pressure bonding, which may cause wrinkles and, in the worst case, a breakage of the lithium metal W5 or the copper foil W6. By sandwiching the lithium metal W5 by the copper foils W6 from both surfaces of the lithium metal W5, it is possible to avoid the above concerns and to significantly improve the productivity.

Moreover, it is easy to handle the layered member 20 in which the lithium metal W5 is sandwiched by the copper foils W6 from both surfaces. That is, since such a layered member 20 has a high bending strength compared to when the copper foil W6 is affixed to one surface of the lithium metal W5, wrinkles are unlikely to be caused while handling. Further, since the layered member 20 has a high cutting strength and cannot readily be cut, the peripheral surface of the roll accordingly does not directly contact the lithium metal W5, thereby attaining safety. Furthermore, the lithium metal W5 is unlikely to peel off while handling.

In the layered member 20 in which the lithium metal W5 is sandwiched by the copper foils W6 from both surfaces thereof, both the copper foils W6 are provided with tabs for connection to the negative electrode. Thus, the density of the tabs formed on the copper foils W6 is doubled for the lithium metal W5 of the same area. This reduces the resistance in connection with the negative electrode to promote occlusion of lithium ions in the negative electrode compared to when the copper foil W6 is affixed to one surface of the lithium metal W5. In addition, the lithium metal W5 is prevented from slipping off from the copper foils W6. As the result, all the lithium metal W5 is dissolved and the lithium ions dissolved from the lithium metal are occluded in the negative electrode. In addition, it is possible to prevent a short circuit from occurring because the lithium metal does not slip off. Even if some of the lithium metal W5 is not dissolved but left, such remaining lithium metal W5 is sandwiched between the copper foils W6 not to slip off, thereby improving the safety.

If the lithium metal W5 is electrically connected to the negative electrode to cause lithium ions to be occluded only by the potential difference between the lithium metal W5 and the negative electrode as in the embodiment, the occlusion progresses less and less as the depth of the occlusion in the negative electrode becomes deeper and deeper. Therefore, in order for the lithium metal W5 disposed in the container 8 to be completely occluded in the negative electrode and not to be left in the container 8, it may be necessary to use an amount of the lithium metal W5 that is less than the theoretical amount. If the capacitor is charged by float charging at a high temperature and a high voltage for a long period, for example, as a reaction between lithium ions in the electrolyte and the positive active material and the negative active material progresses, the lithium ions are gradually irreversibly discharged from the negative electrode. Thus, the reliability of the capacitor is higher as the amount of lithium ions occluded in the negative electrode in advance is larger (closer to the theoretical amount).

According to the present embodiment, since the lithium metal W5 in the layered member 20 does not slip off even if a part of the lithium metal WT5 is left in the container 8, the lithium metal is eventually dissolved in the container 8 and the lithium ions are occluded in the negative electrode. In the present embodiment, reliability of the capacitor maybe increased because the theoretical amount of lithium ions can be occluded in the negative electrode without compromising the safety by disposing the layered member 20 in which the lithium metal W5 is sandwiched between the copper foils W6 in the container 8.

In the present embodiment, the through holes are substantially uniformly distributed in the portions formed with the through holes of the copper foils W3 of the layered members 20A and 20B, and the layered members 20A and 20B are disposed at both the inner peripheral portion and the outer peripheral portion of the electrode group 7. Thus, it is possible to shorten the period for which the capacitor 30 is left to stand, and to allow lithium ions to be substantially uniformly occluded in the negative active material. In the capacitor 30 according to the embodiment, moreover, the layered members 20A and 20B are disposed on an extension line of the wound negative electrode 3. The layered members 20A and 20B are disposed between two surfaces of the two separators 4 sandwiching the negative electrode 3. The layered members 20A and 20B face the negative electrode 3. Therefore, it is possible to shorten the period for which the capacitor 30 is left to stand, and to promote lithium ions to be uniformly occluded by the amorphous carbon.

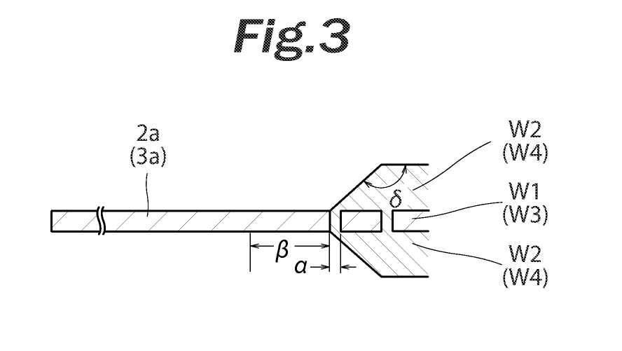

In the capacitor 30 according to the embodiment, further, the aluminum foil W1 forming the positive electrode, the copper foil W3 forming the negative electrode 3 and the copper foils W6 forming the layered members 20A and 20B include a portion formed with no through holes that is located adjacent to the lead pieces or the tabs. In the layered members 20A and 20B, in addition, the area of the portion with the through holes is set to be larger than the area of the lithium metal W5. Therefore, even if the positive electrode 2, the negative electrode 3, and the layered members 20A and 20B with the separators 4 provided therebetween are wound to form the electrode group 7, the base portions of the lead pieces or the tabs are not swelled and edged projections are not formed by the active material mixtures applied to the aluminum foil W1 or the copper foil W3 or the lithium metal sandwiched by the copper foils W6. Consequently, it is possible to prevent a breakage of the separators 4 and an internal short circuit due to such a breakage even after a long period of use. Thus, the capacitor 30 having a long life may be obtained. The terminal structure of the electrode shown in FIG. 3 also contributes to the long life of the capacitor.

Moreover, the capacitor 30 according to the embodiment is filled with the insulating material 11 from the inner bottom surface of the container 8 to the upper portion of the negative current collector ring 6. Therefore, it is possible to prevent lithium ions from the lithium metal W5 from being precipitated into other members forming the negative electrode, rather than being occluded by the negative active material, to cause a breakage of the separators 4 or the like. It is also possible to set the total charge amount of the lithium metal W5 to be close to the theoretical total charge amount, to make the lithium metal W5 as thin as possible, and to prevent the wound electrode group 7 from being weakened. Further, a free electrolyte can be eliminated by providing the insulating material 11 from the inner bottom surface of the container 8 to the upper portion of the negative current collector ring 6.

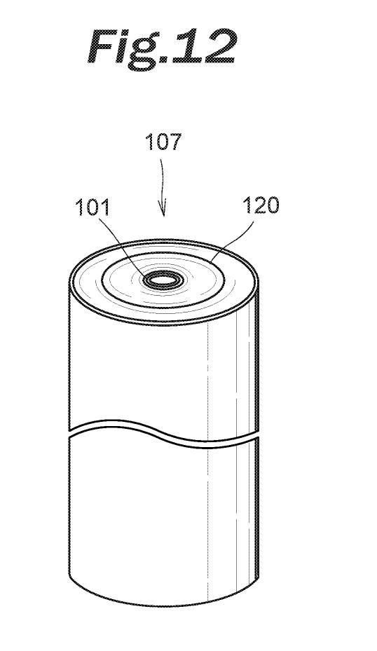

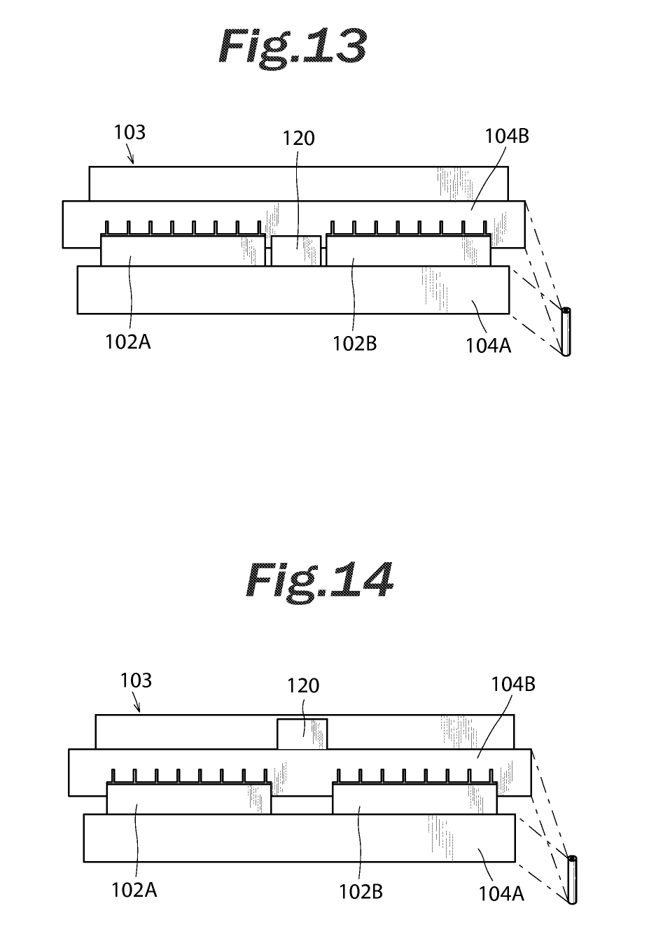

In the above embodiment, the layered members 20 are disposed at two locations, namely at the inner peripheral portion and the outer peripheral portion of the electrode group 7. However, the present invention is not limited thereto. For example, as shown in FIGS. 12, 13, and 14, a layered member 120 may be provided at one location in an electrode group 107. In such configurations, the positive electrode is formed by two divided positive electrodes 102A and 102B. The layered member 120 may be disposed between the two divided positive electrodes 102A and 102B such that both surfaces of the layered member 120 respectively face the negative electrode 103 via the separators 104A and 104B as shown in FIG. 13. Alternatively, the layered member 120 may be disposed on the negative electrode 103 such that one of both surfaces of the layered member 120 directly face the negative electrode 103 and the other surface of the both surfaces of the layered member 120 faces the negative electrode 103 via a separator 104A and 104B and a gap between the two divided positive electrodes 102A and 102B as shown in FIG. 14. In the configurations shown in FIGS. 13 and 14, the layered member 120 is preferably disposed at the middle of the wound electrode group 107 (for example, at the middle of the length of the electrode group 107 from the wound start portion to the wound end portion). Also in such configurations, the separators 104A and 104B and the negative electrode 103 are preferably not divided in the electrode group 107 as in the above embodiment.

In the embodiment described with reference to FIGS. 1 to 11, each of the layered members 20A and 20B is wound by one turn. However, the present invention is not limited thereto, and each of the layered members 20A and 20B may be wound by a plurality of turns. In this case, the metal foils (copper foils) of the layered members 20A and 20B may be made thicker than the copper foil of the negative electrode 3 to prevent the electrode group 7 from being weakened by dissolution of the lithium metal. Conversely, if winding the layered member by more than one turn makes the overlapping portion disadvantageously thicker, the layered member may be wound by one turn or less at each of a plurality of locations. It is considered that this configuration may better prevent the electrode group 7 from being weakened.

In the embodiment, further, the present invention is applied to a lithium ion capacitor in a wound configuration. However, it is a matter of course that the present invention is applicable to a lithium ion capacitor in a layered structure. In a lithium ion capacitor in the layered structure, the electrode group is formed by layering positive and negative electrodes with separators provided therebetween and disposing a negative electrode on both sides of the electrode group. In this case, the layered member may be disposed on the outer side of the negative electrodes via a separator. Alternatively, the layered member may be disposed in the electrode group. In this case, the layered member is preferably disposed such that both surfaces of the layered member face a negative electrode via a separator. In the embodiment, in addition, the axial core 1 is disposed at the center of the electrode group 7. However, the present invention is not limited thereto, and is applicable to a lithium ion capacitor that uses an electrode group with no axial core.

In the embodiment, in addition, an active material mixture is applied to both surfaces of the electrode. However, the present invention is not limited thereto, and may be applied to electrodes, to only one surface of which an active material mixture is applied. In the embodiment, further, the through holes formed in portions of the positive and negative electrodes and the layered members have a circular shape. However, the present invention is not limited thereto. That is, the through holes may have any shape such as a polygonal shape such as a triangular or quadrangular shape, a star shape, or a trapezoidal shape, for example. In the embodiment, moreover, the through holes formed in portions of the positive and negative electrodes and the layered members have an aperture ratio of 20%. However, the present invention is not limited thereto. The aperture ratio may be 5% to 55%, for example, preferably 10% to 40%, and more preferably 10% to 25%.

In the embodiment, furthermore, two separators 4A and 4B, or 104A and 104B, are used. However, the present invention is not limited thereto. That is, one separator may be used in a folded state to serve as two separators. In addition, a thin separator in two or three folds may be used in place of one separator. Thus, the inventors consider that separators in such configurations have the same meaning as or are equivalent to the “two separators”.

In the embodiment, in addition, the lithium metal W5 has a rectangular plate shape. In the present invention, however, the shape of the lithium metal W5 is not limited. For example, the lithium metal W5 may have a circular plate shape or a trapezoidal plate shape. Also, the shape of the container 8 is not limited to a cylindrical shape, and the container 8 may have an oval shape, an elongated circular shape, or a rectangular shape in cross section. Equivalents of the cylindrical shape include those with an oval, elongated circular, or rectangular lateral cross section besides a circular lateral cross section. In the embodiment, furthermore, an epoxy resin is used as the insulating material 11. However, it is a matter of course that other resins known in the art may also be used. In the embodiment, in addition, various numerical values are mentioned as examples for ease of understanding. However, it is to be understood that the present invention is not limited by any value other than those defined in the claims.

In the embodiment, further, specific members for fabricating a lithium ion capacitor are illustrated. However, the present invention is not limited by any member other than those mentioned in the claims. Thus, any member and any material known in the art at the time of filing of the present application may be used.

In the above embodiment, copper foils are used as the metal foils of the layered member 20. However, the present invention is not limited thereto, and copper alloy foils, nickel foils, or nickel alloy foils, for example, may be used in consideration of the cost or the like.

While certain features of the invention have been described with reference to example embodiments, the description is not intended to be construed in a limiting sense. Various modifications of the example embodiments, as well as other embodiments of the invention, which are apparent to persons skilled in the art to which the invention pertains, are deemed to lie within the spirit and scope of the invention.

1. A lithium ion capacitor comprising:
an electrode group including a positive electrode, a negative electrode, and a separator, the positive electrode having a positive current collector and an active material mixture supported on the positive current collector and the negative electrode having a negative current collector and an active material mixture supported on the negative current collector;
a non-aqueous electrolyte;
a container for housing the electrode group and the non-aqueous electrolyte; and
a layered member as a lithium ion source disposed in or adjacent to the electrode group while being electrically insulated from the positive electrode, the layered member comprising:
two metal foils each including a portion in which a large number of through holes are formed and a portion in which through holes are not formed and which is provided adjacent to the portion with the through holes; and
lithium metal having a thin plate shape and sandwiched between the two metal foils to contact the portions with the through holes of the two metal foils,
wherein only the metal foils are left in the layered member with the lithium metal occluded by a negative active material in the active material mixture of the negative electrode.

2. The lithium ion capacitor according to claim 1, wherein
the positive and negative electrodes are wound with the separator provided therebetween, a positive current collector connected to the positive electrode and a negative current collector connected to the negative electrode each have a profile selected from a ring shape, a triangular shape, and a polygonal shape, the container has a cylindrical shape, and the layered member is wound around an axial core while being electrically insulated from the positive electrode.

3. The lithium ion capacitor according to claim 2, wherein
an end of the separator at which winding is started is fixed to the axial core, an end of the separator at which the winding is finished forms the peripheral surface of the electrode group, and the separator is not divided in the electrode group.

4. The lithium ion capacitor according to claim 1, wherein
the layered member is wound in the electrode group at at least one of a position leading to a wound start portion of the negative electrode, a position corresponding to the wound portion of the negative electrode, and a position following the wound end portion of the negative electrode.

5. The lithium ion capacitor according to claim 1, wherein:
the positive electrode comprises at least two divided positive electrodes which are spaced from each other in the longitudinal direction of the positive electrode, the layered member being disposed between two of the divided positive electrodes; and
both surfaces of the layered member face the negative electrode via the separator.

6. The lithium ion capacitor according to claim 1, wherein
the positive electrode comprises at least two divided positive electrodes which are spaced from each other in the longitudinal direction of the positive electrode, the layered member being disposed on a surface portion of the negative electrode facing a space between two of the divided positive electrodes not via the separator.

7. The lithium ion capacitor according to claim 6, wherein
the layered member is wound by one turn or less in the electrode group.

8. A layered member as a lithium ion source for a lithium ion capacitor that causes a negative active material to occlude lithium ions in advance in a container for a lithium ion capacitor, the layered member comprising:
two metal foils each including a portion in which a large number of through holes are formed and a portion in which through holes are not formed and which is provided adjacent to the portion with the through holes; and
lithium metal having a thin plate shape and sandwiched between the two metal foils to contact the portions with the through holes of the two metal foils.

9. The layered member according to claim 8, wherein
the portion without through holes is provided with a plurality of tabs formed at predetermined intervals.

10. The layered member according to claim 8, wherein
the lateral cross-sectional area of the through hole formed in the portion with the through holes of the metal foils is 8×10⁻⁷ m² or less.

11. The layered member according to claim 8, wherein
the area of the portion with the through holes is larger than the area of the lithium metal.

12. The layered member according to claim 8, wherein
the metal foils are made of a material selected from the group consisting of copper, nickel, a copper alloy, and a nickel alloy.

13. The layered member according to claim 9, wherein
the area of the portion with the through holes is larger than the area of the lithium metal.
